(19) United States
(12) Patent Application Publication
(10) Pub. No.: US 2006/0168607 A1
(43) Pub. Date: Jul. 27, 2006

(54) Objective-lens driving apparatus, optical pickup and optical disk apparatus

(75) Inventors: Hideo Ohkuma, Tokyo (JP); Sanae Hanaoka, Shizuoka (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: Sony Corporation, Shinagawa-ku (JP)

(21) Appl. No.: 11/324,377

(22) Filed: Jan. 4, 2006

(30) Foreign Application Priority Data
Jan. 17, 2005 (JP) 2005-009617

(51) Int. Cl. G11B 7/09; G11B 7/085; G11B 7/08

(52) U.S. Cl. 720/683

(57) ABSTRACT

The present invention provides an objective-lens driving apparatus in which the phase delay is small in focusing-response characteristic and which excels in resonance characteristic in high-frequency bands. The objective-lens driving apparatus includes a movable unit that has a lens holder holding an objective lens, a fixed unit that is spaced apart from the movable unit in a tangential direction, elastic support members that support the movable unit, enabling the movable unit to move with respect to the fixed unit in the focusing direction and tracking direction and to incline in a tilt direction, a first magnet, and a second magnet that is magnetized in a direction opposite to a magnetization direction of the first magnet. The lens holder has tracking coils, focusing coils, a first tilt coil that is wound around an axis extending in the focusing direction and generates drive forces acting in the tilt direction, and a second tilt coil that is wound around in a direction opposite to the winding direction of the first tilt coil, and generates drive forces acting in the tilt direction.

### CROSS REFERENCE TO RELATED APPLICATIONS

The present invention contains subject matter related to Japanese Patent Application JP 2005-009617 filed in the Japanese Patent Office on Jan. 17, 2005, the entire contents of which being incorporated herein by reference.

### BACKGROUND OF THE INVENTION

1. Field of the Invention

The present invention relates to an objective-lens driving apparatus for use in an optical pickup that records and reproduces data in and from a data-recording medium such as an optical disc, said apparatus designed to drive an objective lens in three directions, i.e., focusing direction, tracking direction and tilt direction. The invention relates to an optical pick up and an optical disc apparatus, which use the objective-lens driving apparatus.

2. Description of the Related Art

Optical disc apparatuses are known, which record and reproduce data in and from a data-recording medium such as an optical disc. Any optical disc apparatus of this type has an optical pickup that is moved in the radial direction of an optical disc and applies a laser beam to the optical disc.

The optical pickup incorporates an objective-lens driving apparatus that drives the objective lens held by a movable unit. The apparatus moves the objective lens in the focusing direction, namely toward and away from the signal-recording surface of the optical disc, thus accomplishing the focusing adjustment. The apparatus moves the objective lens in the tracking direction, too, namely in the radial direction of the optical disc, thus achieving the tracking adjustment. Further, the apparatus moves the objective lens, thus adjusting the spot that the laser beam applied through the objective lens forms on the optical disc. Hence, the laser beam applied through the objective lens to the optical disc converges, forming a spot on the recording track of the optical disc.

Most objective-lens driving apparatuses for use in optical pickups perform the focusing adjustment and the tracking adjustment. In recent years, an objective-lens driving apparatus, such as a so-called three-axis actuator, has been developed. This apparatus not only performs the two-axis adjustment, i.e., focusing adjustment and tracking adjustment, but also tilts the movable unit to the signal-recording surface of the optical disc. The apparatus can therefore accomplish adjustment to compensate for the planer vibration or the like of the optical disc, which may occur while the disc is rotating. (See Jpn. Pat. Appln. Laid-Open Publication 2001-93177).

The objective-lens driving apparatus, such as three-axis actuator, can move the movable unit with respect to the fixed unit, in not only the focusing direction and tracking direction, but also the tilt direction. In the tilt direction, the movable unit can be rotated around an axis that corresponds to the tangential direction extending at right angles to the radial direction of the optical disc.

An objective-lens driving apparatus is known, which is shown in FIG. 1. In this objective-lens driving apparatus, the movable unit holding an objective lens is movably supported by a support spring to a fixed block, and a tilt coil is secured to the movable unit and can incline a movable block to the fixed block.

As FIG. 1 shows, the objective-lens driving apparatus 101 includes a yoke 102, a movable unit 104, a fixed unit 105, a pair of magnets 106 and 107, and an elastic support member 108. The yoke 102 is inserted in a focusing coil and a tilt coil, which will be described later. The movable unit 104 holds an objective lens 103. The fixed unit 105 is arranged, spaced apart from the movable unit 104. The magnets 106 and 107 are mounted on the fixed unit 105 and arranged, facing the movable unit 104. The elastic support member 108 supports the movable unit 104, allowing the unit 104 to move with respect to the fixed unit 105 in the focusing direction F_{CS} and the tracking direction T_{RK} and to incline in the tilt direction T_{IL}.

As FIG. 1 and FIG. 2 show, the movable unit 105 includes a focusing coil 111, tracking coils 112, 113, 114 and 115, and tilt coils 116 and 117. The focusing coil 111 is wound around an axis that extends in the focusing direction F_{CS}. The tracking coils 112 to 115 are wound around axes that extend in the tangential direction T_{AN}. The tilt coils 116 and 117 are wound around axes that extend in the focusing direction F_{CS}.

In the objective-lens driving apparatus 101 shown in FIGS. 1 and 2, a current may be supplied to the focusing coil 111, tracking coils 112 to 115 and tilt coils 116 and 117. When a current is so supplied, the movable unit 104 moves with respect to the fixed unit 105, in the focusing direction F_{CS}, tracking direction T_{RK} and tilt direction T_{IL}, in accordance with the relation between the current-supplying direction and the direction of the magnetic flux generated by the magnets 106 and 107 and yoke 102.

The objective-lens driving apparatus 101 can not accomplish only focusing adjustment and tracking adjustment, but also performs adjustment to compensate for planer vibration, if any, of the optical disc. Thus, the apparatus 101 can make the laser-beam spot trace the recording track more accurately.

This objective-lens driving apparatus 101 is a magnetic circuit that includes the focusing coil 111 of voice-coil type wound around the axis extending in the focusing direction F_{CS}, and the yoke 102 inserted in the focusing coil 111. The apparatus 101 inevitably has focusing-response characteristics including a prominent phase delay, because of inductance components. If the apparatus 101 is used in high-speed data-reproducing apparatuses, it may impose problems in achieving servo design for the data-reproducing apparatuses.

As FIG. 3 depicts, in the objective-lens driving apparatus 101, focusing drive force F_{S3} acts at a midpoint with respect to the tracking direction T_{RK}. Thus, the focusing thrust is concentrated at the midpoint. The resonance mode, i.e., a primary bending mode in the movable unit, is inevitably excited, possibly raising the resonance peak level.

### SUMMARY OF THE INVENTION

It is therefore desirable to provide an objective-lens driving apparatus, an optical pickup and an optical disc apparatus, in which the phase delay is small in focusing-response characteristic and no primary bending mode is excited in the movable unit when the unit receives a focusing thrust, and which therefore excel in resonance characteristic in high-frequency bands.

According to the present invention, there is provided an objective-lens driving apparatus which includes: a movable unit that has a lens holder holding an objective lens; a fixed unit that is spaced apart from the movable unit in a tangential direction intersecting at right angle to a focusing direction and tracking direction of the objective lens; elastic support members that connect the movable unit and the fixed unit to each other, support the movable unit, enabling the movable unit to move with respect to the fixed unit in the focusing direction and tracking direction and to incline in a tilt direction to a plane that is parallel to the tangential direction; a first magnet that has first to fourth segment regions facing the lens holder in the tangential direction, spaced from one another in the focusing direction and tracking direction and magnetized in the tangential direction; and a second magnet that is arranged, facing the first magnet in the tangential direction, and is magnetized in a direction opposite to a magnetization direction of the first magnet. The lens holder has: tracking coils that are provided at four positions, respectively, for generating drive forces acting in the tracking direction, respectively on the first and second segment regions of the first magnet, which are adjacent in the tracking direction, on the third and fourth segment regions of the first magnet, which are adjacent in the tracking direction, on those segment regions of the second magnet, which face the first and second segment regions, and on those segment regions of the second magnet, which face the third and fourth segment regions; focusing coils that are provided at four positions, respectively, for generating drive forces acting in the focusing direction, respectively on the first and third segment regions of the first magnet, which are adjacent in the focusing direction, on the second and fourth segment regions of the first magnet, which are adjacent in the focusing direction, on those segment regions of the second magnet, which face the first and third segment regions, and on those segment regions of the second magnet, which face the second and fourth segment regions; a first tilt coil that is wound around an axis extending in the focusing direction and generates drive forces acting in the tilt direction, respectively on the first and second segment regions of the first magnet, which are adjacent in the tracking direction, and on those segment regions of the second magnet, which face the first and second segment regions; and a second tilt coil that is wound around in a direction opposite to the winding direction of the first tilt coil, and generates drive forces acting in the tilt direction, respectively on the third and fourth segment regions of the first magnet, which are adjacent in the tracking direction, and on those segment regions of the second magnet, which face the third and fourth segment regions.

According to the present invention, there is also provided an optical pickup which includes a movable base that is moved in a radial direction of an optical disc placed on a disc table, and an objective-lens driving apparatus that is arranged on the movable table. The objective-lens driving apparatus is of the type described above.

According to the present invention, there is also provided an optical disc apparatus which includes a disc table on which an optical disc is to be placed, and an optical pickup which applies a laser beam through an objective lens to the optical disc placed on the disc table. The optical pickup has a movable base that is moved in a radial direction of an optical disc placed on a disc table, and an objective-lens driving apparatus that is arranged on the movable base. The objective-lens driving apparatus is of the type described above.

The objective-lens driving apparatus, optical pickup and optical disc apparatus according to the present invention can reduce the phase delay in focusing-response characteristic. This makes it easy to accomplish, for example, servo design for high-speed, data-recording/reproducing apparatuses. Further, the objective-lens driving apparatus, optical pickup and optical disc apparatus according to this invention can prevent the primary bending mode in the movable unit from being excited, by using focusing drive forces. Hence, they can acquire good resonance characteristics in high-frequency bands.

### BRIEF DESCRIPTION OF THE DRAWINGS

FIG. 1 is a perspective view of a conventional objective-lens driving apparatus;

FIG. 2 is a perspective view representing the positional relation between the focusing coil, tracking coils and tilt coils of the conventional objective-lens driving apparatus;

FIG. 3 is a side view explaining the relation between the focusing thrust and the resonance of primary bending mode of the movable unit, which is observed in the conventional objective-lens driving apparatus;

FIG. 4 is a perspective view schematically illustrating a data-recording/reproducing apparatus according to the present invention;

FIG. 5 is a perspective view of an objective-lens driving apparatus according to this invention;

FIG. 6 is a perspective view showing the yoke base of the objective-lens driving apparatus according to the invention, and showing the fixed unit and movable unit of the apparatus;

FIG. 7 is a perspective view of the objective-lens driving apparatus according to the invention, as viewed from the back;

FIG. 8 is a perspective view of the objective-lens driving apparatus according to the invention, as viewed from the back, illustrating the positional relation between the magnets and the coils;

FIG. 9 is an exploded perspective view schematically showing how the magnets and the printed coil are arranged in the objective-lens driving apparatus according to the present invention;

FIGS. 10A and 10B represent the directions in which the magnets are magnetized in the objective-lens driving apparatus according to this invention, FIG. 10A being a plan view of that side of the apparatus which faces the lens holder of the first magnet, and FIG. 10B being a plan view of that side of the apparatus which faces the lens holder of the second magnet;

FIG. 11 is an exploded perspective view schematically showing how the magnets and tilt coils are arranged in the objective-lens driving apparatus according to this invention;

FIG. 12 is a side view explaining the relation between the resonance and the focusing thrust observed in the objective-lens driving apparatus according to this invention when the movable unit operates in the primary bending mode;

FIGS. 13A to 13F are diagrams explaining the sequence of forming tilt coil for use in the objective-lens driving apparatus according to the invention, FIG. 13A being a left-side view showing one side perpendicular to the tracking direction T_{RK} and the initial stage of winding a coil around a winding-start projection, FIG. 13B being a plan view depicting the direction in which a first tilt coil is wound, FIG. 13C being a right-side view showing the other side perpendicular to the tracking direction and the first tilt coil completely wound, FIG. 13D being a left-side view showing the initial stage of winding the second tilt coil after the coil-winding direction has been reversed, FIG. 13E being a plan view showing the direction in which the second tilt coil is wound, and FIG. 13F being a right-side view illustrating the second tilt coil completely wound;

FIGS. 14A and 14B are graphs showing how the phase and gain change with the frequency in the objective-lens driving apparatus according to this invention and in a comparative objective-lens driving apparatus, FIG. 14A being a graph illustrating how the gain changes with the frequency, and FIG. 14B being a graph illustrating how the phase changes with the frequency;

FIG. 15 is a graph that demonstrates how the gain changes with the frequency in the objective-lens driving apparatus according to this invention and in the comparative objective-lens driving apparatus;

FIGS. 16A and 16B depict the first and second magnets used in the objective-lens driving apparatus according to the present invention, FIG. 16A being an exploded perspective view and FIG. 16B being a perspective view showing the magnets joined together, side to side; and

FIGS. 17A and 17B depict first and second magnets of another type, for use in the objective-lens driving apparatus according to this invention, FIG. 17A being an exploded perspective view and FIG. 17B being a perspective view showing the magnets joined together, arranged in the focusing direction.

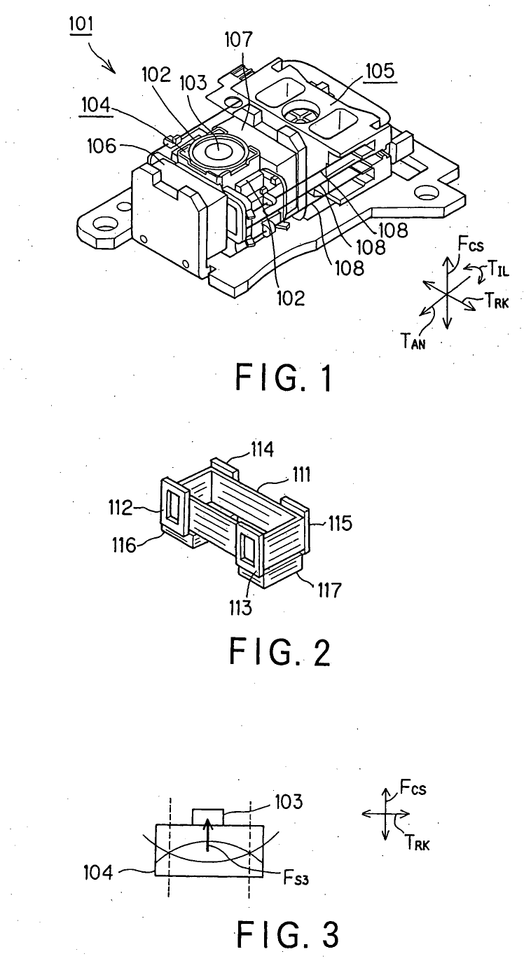

### DETAILED DESCRIPTION OF THE PREFERRED EMBODIMENTS

A data-recording/reproducing apparatus according to the present invention will be described, with reference to the accompanying drawings.

The data-recording/reproducing apparatus 1 can record and reproduce data signals in and from an optical disc 2. The optical disc 2, in and from which the apparatus 1 can record and reproduce data, is, for example, a compact disc (CD), a digital versatile disc (DVD), a recordable CD (CD-R), a recordable DVD (DVD-R), a rewritable CD (CD-RW), or a rewritable DVD (DVD-RW), a rewritable DVD (DVD+RW). Note that data can be recorded in the CD-R and the DVD-R and rewritten in the CD-RW, the DVD-RW and the DVD+RW. Alternatively, the optical disc 2 may be one in which data can be recorded at high density by applying laser beam emitted from a semiconductor laser and having a short wavelength of about 405 nm. Further, the optical disc 2 may be replaced by a magneto-optical disc or the like.

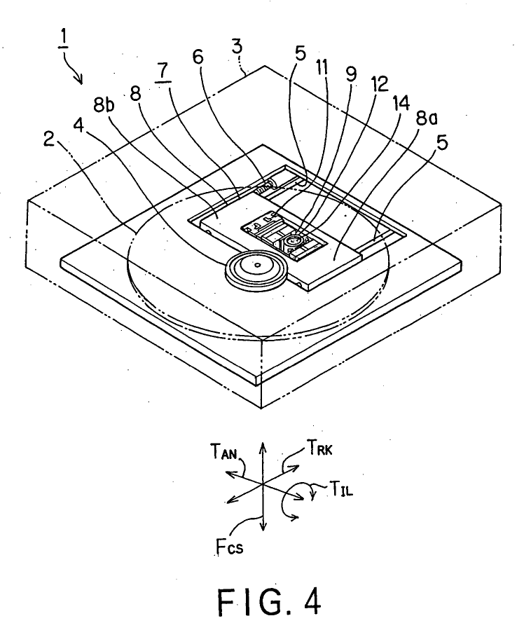

As FIG. 4 shows, the data-recording/reproducing apparatus 1 includes a housing 3 and various components and mechanisms incorporated in the housing 3. The housing 3 has a disk-insertion slot (not shown).

A chassis (not shown) is arranged in the housing 3. The chassis holds a spindle motor. A disc table 4 is secured to the shaft of the spindle motor.

Parallel guide rods 5 are secured to the chassis. The chassis supports a lead screw 6 that can be rotated by a feed motor (not shown).

The data-recording/reproducing apparatus 1 includes an optical pickup 7. As FIG. 4 depicts, the optical pickup 7 has a movable base 8, optical components mounted on the movable base 8, and an objective-lens driving apparatus 9 arranged on the movable base 8. Bearings 8a and 8b are provided at the ends of the movable base 8 and mounted on the guide rods 5, respectively. The bearings 8a and 8b can slide on the guide rods 5.

A nut (not shown) is provided on the movable base 8 and set in screw engagement with the lead screw 6. When lead screw 6 is rotated by the feed motor, the nut moves in one direction or the other in accordance with the direction in which the lead screw 6 is rotated. The optical pickup 7 is therefore moved in the radial direction of the optical disc 2 placed on the disc table 4.

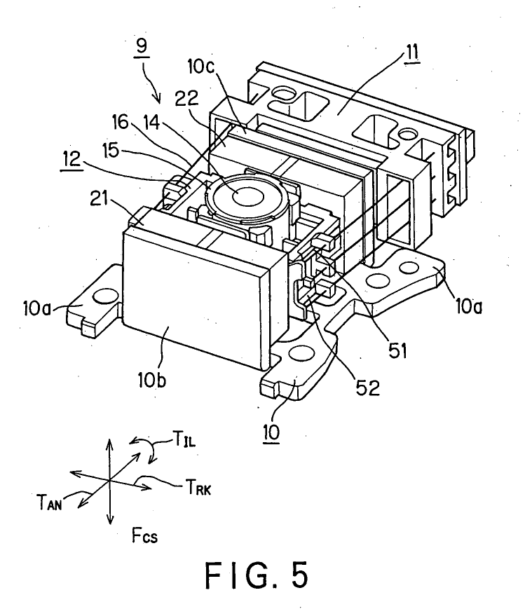

As shown in FIGS. 5, 6 and 7, the objective-lens driving apparatus 9 includes a yoke base 10, a fixed plate (not shown), a movable unit 12, a fixed unit 11, and a plurality of elastic support members 16. The fixed plate is spaced apart from the yoke base 10 in a tangential direction T_{AN} and secured to the movable base 8. The movable unit 12 has a lens holder 15 that holds an objective lens 14. The fixed unit 11 is arranged, spaced from the movable unit 12 in the tangential direction T_{AN} that extends at right angles to the focusing direction F_{CS} and tracking direction T_{RK} in which the objective lens 14 can be moved. The elastic support members 16 couple the fixed unit 11 and the movable unit 12 to each other. The members 16 support the movable unit 12, allowing the unit 12 to move in both the focusing direction F_{CS} and the tracking direction T_{RK}, with respect to the fixed unit 11. Further, the members 16 allow the movable unit 12 to incline in tilt direction T_{IL} to a plane that is parallel to the tangential direction T_{AN} of the optical disc.

The yoke base 10 is made of magnetic metal such as SPCC (cold-rolled steel), silicon steel or the like. As FIG. 5 shows, the yoke base 10 is composed of a base part 10a and yoke parts 10b and 10c. The base part 10a is fixed to the movable base 8. The yoke parts 10b and 10c stand at right angles from the base part 10a. The yoke parts 10b and 10c are spaced in the depth direction of the yoke base 10. That is, they are spaced apart in the tangential direction T_{AN} of the optical disc 2.

First and second magnets 21 and 22 are secured, respectively to one side of the yoke part 10c and that side of the yoke part 10b which faces said one side of the yoke part 10c. The sides of the yoke parts 10b and 10c, to which the magnets 21 and 22 are secured, are opposed to the lens holder 15.

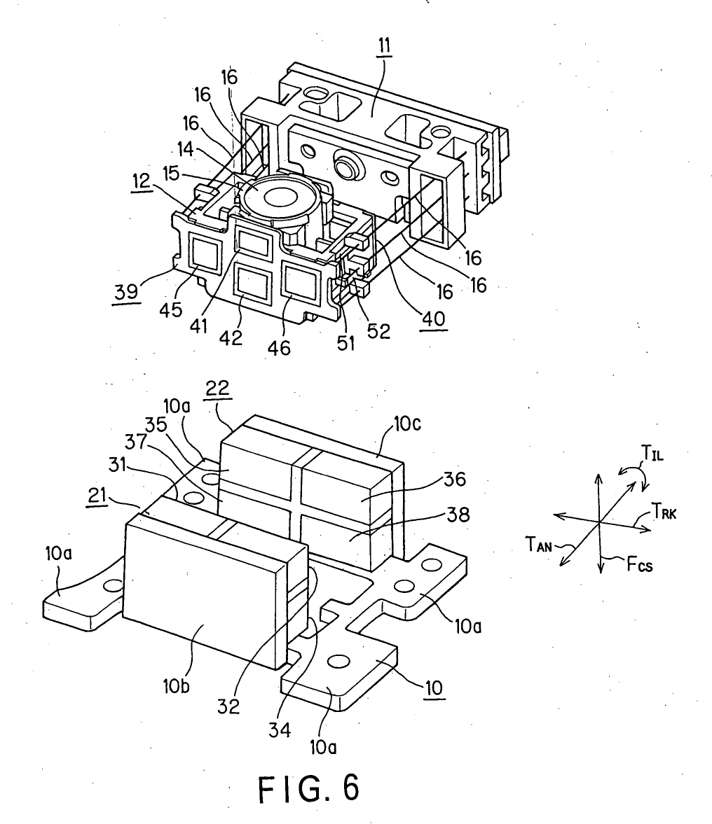

As shown in FIGS. 6, 9 and 10, the first magnet 21 is arranged, facing the lens holder 15 in the tangential direction T_{AN}. The first magnet 21 is composed of first to fourth segment regions 31, 32, 33 and 34 arranged in the focusing direction F_{CS} and tracking direction T_{RK}. The first to fourth segment regions 31 to 34 are magnetized in the tangential direction T_{AN}.

In the first magnet 21, the first to fourth segment regions 31, 32, 33 and 34, which face the lens holder 15, namely first printed coil 39 and tilt coils 51 and 52 (later described), are shaped like substantially a square and spaced in the tracking direction T_{RK} and focusing direction F_{CS}. The first and fourth segment regions 31 and 34, which are located at two opposite corners, are S poles. The second and third segment regions 32 and 33, which are located at the other opposite corners, are N poles. The first magnet 21 is thus magnetized to have four magnetic poles. The region between the segment regions 31 to 34 is a non-magnetized segment region 21a.

The second magnet 22 is arranged, facing the first magnet 21 in the tangential direction T_{AN}, and is magnetized in the direction opposite to the magnetization direction of the first magnet 21. That is, the second magnet 22 is opposed to the lens holder 15 in the tangential direction T_{AN} and has fifth to eighth segment regions 35, 36, 37 and 38 that are spaced in the tracking direction T_{RK} and focusing direction F_{CS} and magnetized in the tangential direction T_{AN}.

In the second magnet 22, the fifth to eighth segment regions 35, 36, 37 and 38, which face the lens holder 15, namely second printed coil 40 and first and second tilt coils 51 and 52 (later described), are shaped like substantially a square and spaced in the tracking direction T_{RK} and focusing direction F_{CS}. The fifth and eighth segment regions 35 and 38, which are located at two opposite corners, are S poles. The sixth and seventh segment regions 36 and 37, which are located at the other opposite corners, are N poles. The second magnet 22 is thus magnetized to have four magnetic poles. The region between the segment regions 35 to 38 is a non-magnetized segment region 22a.

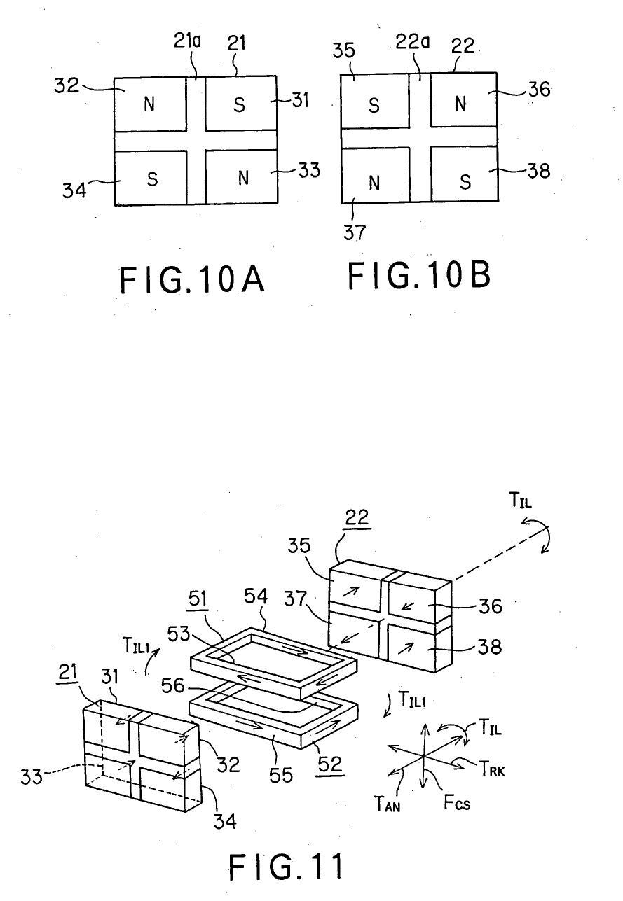

The first magnet 21 and the second magnet 22 are formed in the same shape and magnetized in opposite directions. That is, as FIG. 10 depicts, the first and fourth segment regions 31 and 34 of the first magnet 21, which are arranged at the upper-right corner and the lower-left corner, respectively, are S poles and opposed to the lens holder 15, and the other segment regions 32 and 33 are N poles. On the other hand, the sixth and seventh segment regions 36 and 37 of the second magnet 22, which are arranged at the upper-right corner and the lower-left corner, respectively, are N poles and opposed to the lens holder 15, and the other segment regions 35 and 38 are S poles. As described above, the first and second magnets 21 and 22 are formed in the same shape and divided into segment regions in the same pattern. They are magnetized in opposite directions, in the tangential direction T_{AN}.

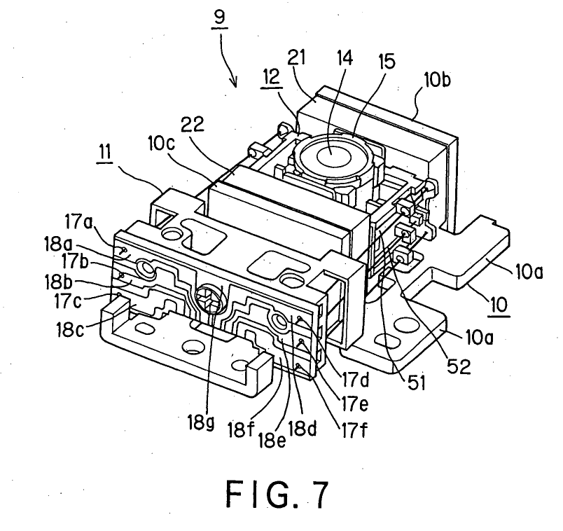

As shown in FIG. 7, the fixed unit 11 is secured on the plate base of the fixed plate. A relay substrate 18 is attached to the back of the fixed unit 11. The relay substrate 18 is composed of a base part 18g and six connecting parts 18a to 18f. The base part 18g is the center part. Of the connecting parts 18a to 18f, some are provided at the left side of the base part 18g, and the others at the right side of the base part 18g. The elastic support members 16 are connected at their ends 17a to 17f to the connecting parts 18a to 18f, respectively, by means of, for example, soldering. Of the ends 17a of the support members 16, three are arranged at one side of the fixed unit 11 in the tracking direction T_{RK} and the other threes are arranged at the other end of the unit 11 and spaced from the first three in the focusing direction F_{CS}.

A power-supplying substrate connected to a power-supply circuit (not shown) is secured to the relay substrate 18 that is attached to the back of the fixed unit 11. The power-supplying substrate is, for example, a flexible printed circuit board. The plurality of support members 16 are connected to the connecting lines provided on the power-supplying substrate, by the connecting parts 18a to 18f of the relay substrate 18. The support members 16 are arranged, each extending from the fixed unit 11 toward the movable unit 12 in the tangential direction T_{AN}.

The movable unit 12 has the objective lens 14 and the lens holder 15. The lens holder 15 holds the objective lens 14.

As FIGS. 6, 8, 9 and 11 show, the lens holder 15 includes first to fourth tracking coils 41, 42, 43 and 44, first to fourth focusing coils 45, 46, 47 and 48, an first and second tilt coils 51 and 52. The tracking coils 41 to 44 are arranged at four positions, respectively, to generate a drive force that acts in the tracking direction T_{RK}, i.e., substantially the radial direction of the optical disc 2. The focusing coils 45 to 48 are arranged at four positions, respectively, to generate a drive force that acts in the focusing direction F_{CS}, i.e., the direction perpendicular to the optical disc 2. The tilt coils 51 and 52 are arranged at two positions, respectively, to generate a drive force that acts in the tilt direction (radial-tilt direction) T_{IL}, i.e., the direction in which the movable unit may be tilted from the tangential direction T_{AN} that extends at right angles to the focusing direction F_{CS} and tracking direction T_{RK}.

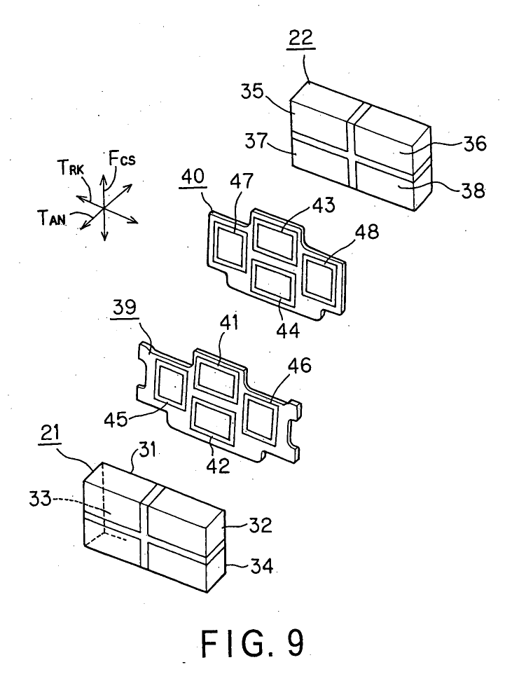

As FIGS. 6 and 9 show, the first to fourth tracking coils 41, 42, 43 and 44 generate drive forces acting in the tracking direction T_{RK}, for the first and second segment regions 31 and 32 of the first magnet 21 that are adjacent in the tracking direction T_{RK}, for the third and fourth segment regions 33 and 34 of the first magnet 21 that are adjacent in the tracking direction T_{RK}, for the segment regions 35 and 36 of the second magnet 22 that face the first and second segment regions 31 and 32, and for the segment regions 37 and 38 of the second magnet 22 that faces the segment regions 33 and 34, respectively.

That is, the first tracking coil 41 is arranged at a specific position, facing the first and second segment regions 31 and 32 of the first magnet 21. It generates a drive force acting the tracking direction T_{RK}, from the magnetic field generated by the first and second segment regions 31 and 32 that are magnetized in the opposite directions, both being tangential direction T_{AN}, and from the current flowing through the first tracking coil 41.

The second tracking coil 42 is arranged at a specific position, facing the third and fourth segment regions 33 and 34 of the first magnet 21. It generates a drive force acting the tracking direction T_{RK}, from the magnetic field generated by the third and fourth segment regions 33 and 34 that are magnetized in the opposite directions, both being tangential direction T_{AN}, and from the current flowing through the second tracking coil 42.

The third tracking coil 43 is arranged at a specific position, facing the fifth and sixth segment regions 35 and 36 of the second magnet 22. It generates a drive force acting the tracking direction T_{RK}, from the magnetic field generated by the fifth and sixth segment regions 35 and 36 that are magnetized in the opposite directions, both being tangential direction T_{AN}, and from the current flowing through the third tracking coil 43.

The fourth tracking coil 44 is arranged at a specific position, facing the seventh and eighth segment regions 37 and 38 of the second magnet 22. It generates a drive force acting the tracking direction T_{RK}, from the magnetic field generated by the seventh and eighth segment regions 37 and 38 that are magnetized in the opposite directions, both being tangential direction T_{AN}, and from the current flowing through the fourth tracking coil 44.

The first to fourth focusing coils 45, 46, 47 and 48 generate drive forces acting in the focusing direction F_{CS}, for the first and third segment regions 31 and 33 of the first magnet 21 that are adjacent in the focusing direction F_{CS}, for the second and fourth segment regions 32 and 34 of the first magnet 21 that are adjacent in the focusing direction F_{CS}, for the segment regions 35 and 37 of the second magnet 22 that face the first and third segment regions 31 and 33, and for the segment regions 36 and 38 of the second magnet 22 that face the segment regions 32 and 34, respectively.

That is, the first focusing coil 45 is arranged at a specific position, facing the first and third segment regions 31 and 33 of the first magnet 21. It generates a drive force acting the focusing direction F_{CS}, from the magnetic field generated by the first and third segment regions 31 and 33 that are magnetized in the opposite directions, both being tangential direction T_{AN}, and from the current flowing through the first focusing coil 45.

The second focusing coil 46 is arranged at a specific position, facing the second and fourth segment regions 32 and 34 of the first magnet 21. It generates a drive force acting the focusing direction F_{CS}, from the magnetic field generated by the second and fourth segment regions 32 and 34 that are magnetized in the opposite directions, both being tangential direction T_{AN}, and from the current flowing through the second focusing coil 46.

The third focusing coil 47 is arranged at a specific position, facing the fifth and seventh segment regions 35 and 37 of the second magnet 22. It generates a drive force acting the focusing direction F_{CS}, from the magnetic field generated by the fifth and seventh segment regions 35 and 37 that are magnetized in the opposite directions, both being tangential direction T_{AN}, and from the current flowing through the third focusing coil 47.

The fourth focusing coil 48 is arranged at a specific position, facing the sixth and eighth segment regions 36 and 38 of the second magnet 22. It generates a drive force acting the focusing direction F_{CS}, from the magnetic field generated by the sixth and eighth segment regions 36 and 38 that are magnetized in the opposite directions, both being tangential direction T_{AN}, and from the current flowing through the fourth focusing coil 48.

The first to fourth tracking coils 41, 42, 43 and 44 are provided on the first printed coil 39. The first to fourth focusing coils 45, 46, 47 and 48 are provided on the second printed coil 40.

That is, the first and second printed coils 39 and 40 are arranged, respectively, on those surfaces of the first and second magnets 21 and 22 which oppose each other and which face the lens holder 15.

The first and second tracking coils 41 and 42 and the first and second focusing coils 45 and 46 are provided on the first printed coil 39 that opposes the first magnet 21. The third and fourth tracking coils 43 and 44 and the third and fourth focusing coils 47 and 48 are provided on the second printed coil 40 that opposes the second magnet 22.

In the objective-lens driving apparatus 9, the first to fourth focusing coils 45 to 48 generate drive forces acting in the focusing direction F_{CS}, because of the open magnetic path defined by the first and second magnets 21 and 22. Therefore, the inductance imposes no influence, and the phase delay can be minimized. That is, in the objective-lens driving apparatus 9, since no yokes are inserted in the focusing coils as in the conventional objective-lens driving apparatus, a phase delay can be prevented, which may result from inductance that should be generated if yokes were inserted in the focusing coils.

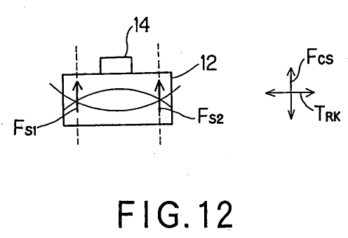

As indicated above, the first and third focusing coils 45 and 47 and the second and fourth focusing coils 46 and 48 are spaced apart in the tracking direction T_{RK} in the objective-lens driving apparatus 9. Hence, it is possible to prevent the primary bending mode of the movable unit from being excited by the focusing drive forces. As FIG. 12 depicts, the focusing thrust may be divided into two focusing thrusts F_{S1} and F_{S2} which act near the nodes of the resonance mode. Then, the resonance is not excited, and the peak level can be improved. That is, in the objective-lens driving apparatus 9, the primary bending mode of the movable unit is not excited, in spite of the focusing drive forces. The apparatus 9 can therefore excel in resonance characteristic in high-frequency bands.

In the objective-lens driving apparatus 9, the first to fourth tracking coils and the first to fourth focusing coils are printed coils. They are not limited to printed coils, nonetheless. They may be, for example, coils that are wound around axes that extend in the tangential direction T_{AN}.

The first and second tilt coils 51 and 52 are spaced apart in the focusing direction F_{CS}. They have been formed by winding wires, are shaped like a hollow cylinder and have substantially the same size.

The first tilt coil 51 is wound around an axis that extends in the focusing direction F_{CS}. It generates drive forces acting in the tilt direction T_{IL}, for the segment regions 31 and 32 of the first magnet 21, which are adjacent in the tracking direction T_{RK}, and for the segment regions 35 and 36 of the second magnet 22 which face the first and second segment regions 31 and 32, respectively.

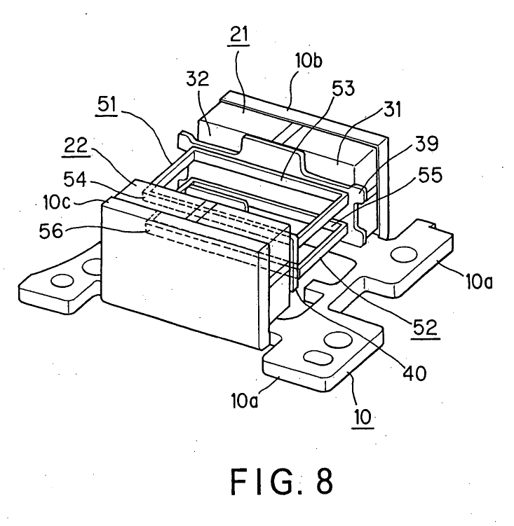

That is, as shown in FIGS. 8 and 11, the first tilt coil 51 has a substantially rectangular cross section. That side 53 of the first tilt coil 51 which opposes the first magnet 21 is positioned, facing the first and second segment regions 31 and 32 of the first magnet 21. The first tilt coil 51 generates a drive force that acts in the tilt direction T_{IL}, from the magnetic field generated by the first and second segment regions 31 and 32 magnetized in opposite directions, both being tangential direction T_{AN}, and from the current flowing through the side 63 of the first tilt coil 51. More specifically, a drive force may be generated, acting in a direction T_{IL1} at that part of the side 53 of the first tilt coil 51, which faces the first segment region 31, to move the lens holder in the focusing direction F_{CS} away from the optical disc 2. In this case, a drive force is generated at that part of the side 53, which faces the second segment region 32. This drive force moves the lens holder away from the optical disc 2 in the focusing direction F_{CS}. This is because a magnetic field acting in one directions is applied to that part of the side 53 of the first tilt coil 51, which faces the first segment region 31, while a magnetic field acting in the opposite direction is applied to that part of the side 53 of the first tilt coil 51, which faces the second segment region 32.

The first tilt coil 51 has a side 54, which opposes not only the above-mentioned side 53 but also the second magnet 22. The side 54 is positioned, facing the fifth and sixth segment regions 35 and 36 of the second magnet 22. The first tilt coil 51 generates a drive force that acts in the tilt direction T_{IL}, from the magnetic field generated by the fifth and sixth segment regions 35 and 36 magnetized in opposite directions, both being tangential direction T_{AN}, and from the current flowing through the side 54 of the first tilt coil 51. To be more specific, a drive force may develop at that part of the side 53 of the first tilt coil 51, which faces the first segment region 31, acting in the direction T_{IL1} to move the lens holder away from the optical disc 2 in the focusing direction F_{CS} as indicated above. Then, the current flows in one direction in that part of the side 54 of the first tilt coil 51, which faces the fifth segment region 35, and in the opposite direction in the side 53, though both directions being the tracking direction T_{RK}. Since both the first region and the fifth region are S poles and the magnetic fields therefore extend in opposite directions, both being the tangential direction T_{AN}, a drive force develops, which acts in the direction T_{IL1}, moving the lens holder toward the optical disc 2 in the focusing direction F_{CS}. At that part of the side 54 of the first tilt coil 51, which faces the sixth segment region 36, a drive force develops, which acts in the direction T_{IL1}, moving the lens holder away from the optical disc 2 in the focusing direction F_{CS}. This is because magnetic fields extending in the opposite directions are applied to those parts of the side 54 of the first tilt coil 51, which face the fifth and sixth segment regions 35 and 36, respectively.

The second tilt coil 52 is wound around an axis that extends in the focusing direction F_{CS}, namely in the direction opposite to the winding direction of the first tilt coil 51. Therefore, the second tilt coil 52 generates a drive force that acts in the tilt direction T_{IL}, at the third and fourth segment regions 33 and 34 of the first magnet 21, which are adjacent in the tracking direction T_{RK}, and at the regions 37 and 38 of the second magnet 22, which oppose the third and fourth segment regions 33 and 34 of the first magnet 21.

That is, the second tilt coil 52 is wound, having a substantially rectangular cross section. It is so positioned that its side 55 opposes the first magnet 21 and faces the third and fourth segment regions 33 and 34 of the first magnet 21. The second tilt coil 52 therefore generates a drive force that acts in the tilt direction T_{IL}, from the magnetic field generated by the third and fourth segment regions 33 and 34 magnetized in opposite directions, both being the tangential direction T_{AN}, and from the current that flows in the side 55 of the second tilt coil 52. Then, a drive force may develop at that part of the side 53 of the first tilt coil 51, which faces the first segment region 31, acting in the direction T_{IL1} to move the lens holder away from the optical disc 2 in the focusing direction F_{CS} as indicated above. To be more specific, the current flows in one direction in that part of the side 55 of the second tilt coil 52, which faces the third segment region 33, and in the opposite direction in the side 53, though both directions being the tracking direction T_{RK}, because the second tilt coil 52 is wound in the direction opposite to the winding direction of the first tilt coil 52. Since the first region and the third region are an S pole and an N pole, respectively and the magnetic fields therefore extend in opposite directions, both being the tangential direction T_{AN}, a drive force develops, which acts in the direction T_{IL1}, moving the lens holder toward the optical disc 2 in the focusing direction F_{CS}. At that part of the side 55 of the second tilt coil 52, which faces the fourth segment region 34, a drive force develops, which acts in the direction T_{IL1}, moving the lens holder away from the optical disc 2 in the focusing direction F_{CS}. This is because magnetic fields extending in the opposite directions are applied to those parts of the side 55 of the second tilt coil 52, which face the third and fourth regions 33 and 34, respectively.

The second tilt coil 52 is so positioned that its side 56, which faces the side 55 and the second magnet 22, opposes the second magnet 22 and faces the seventh and eighth segment regions 37 and 38 of the second magnet 22. The second tilt coil 52 therefore generates a drive force that acts in the tilt direction T_{IL}, from the magnetic field generated by the seventh and eighth segment regions 37 and 38 magnetized in opposite directions, both being the tangential direction T_{AN}, and from the current that flows in the side 56 of the second tilt coil 52. More specifically, a drive force may develop at that part of the side 53 of the first tilt coil 51, which faces the first segment region 31, acting in the direction T_{IL1} to move the lens holder away from the optical disc 2 in the focusing direction F_{CS} as described above. Then, for the same reason described above, a drive force develops at that part of the side 56 of the second tilt coil 52, which faces the seventh segment region 37. The drive force acts in the direction T_{IL1}, moving the lens holder toward the optical disc 2 in the focusing direction F_{CS}. Further, a drive force develops at that part of the side 56 of the second tilt coil 52, which faces the eighth segment region 38. This drive force acts in the direction T_{IL1}, moving the lens holder away from the optical disc 2 in the focusing direction F_{CS}.

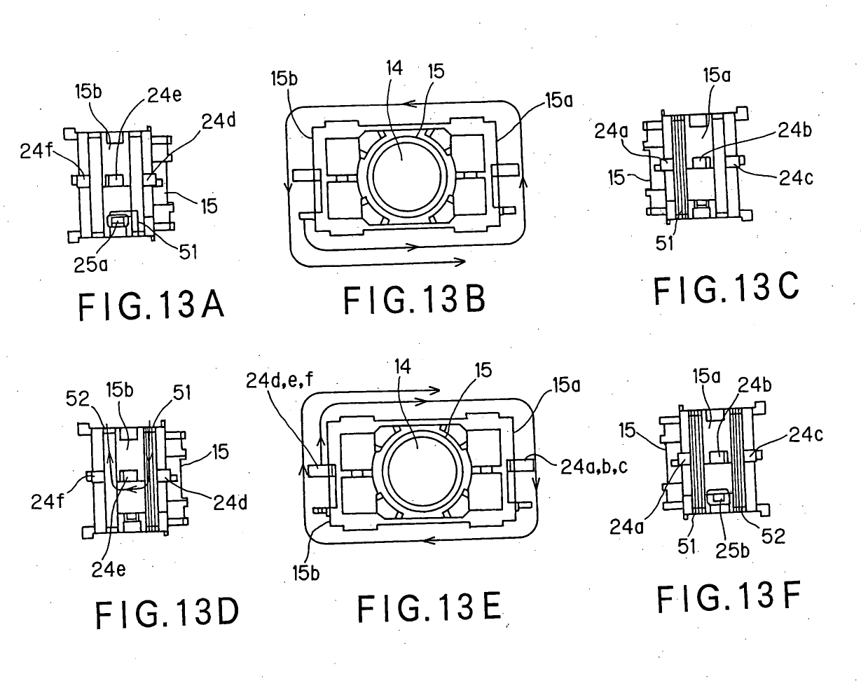

In the surface 15b of the lens holder 15 of the movable unit 12, which is perpendicular to the tracking direction T_{RK}, a projection 24e is provided between the first tilt coil 51 and the second tilt coil 52, as is illustrated in FIG. 13A.

As shown in FIG. 13A to 13F, the first tilt coil 51 is formed by winding a wire in a predetermined direction, and the second tilt coil 52 is then formed by passing the wire around the projection 24e and winding the wire in the opposite direction. The projection 24e is one of the elastic support members 16.

The lens holder 15 has two surfaces 15a and 15b that are perpendicular to the tracking direction T_{RK}. Projections 24a to 24c (i.e., some elastic support members 16) are provided on the surface 15a. Projections 24d to 24f (i.e., the remaining elastic support members 16) are provided on the surface 15b. The projections 24a to 24f are connected, at one end (i.e., end parts 17a to 17f) to the connecting parts 18a to 18f, respectively. The projections 24a to 24f are secured at the other end. Of the projections 24a to 24f, the one that lies middle in the focusing direction F_{CS}, is used to invert the direction in which the wire is wound to form the first and second tilt coils 51 and 52. The lens holder 15 has two other projections 25a and 25b, both provided on the surface 15a that is perpendicular to the tracking direction T_{RK}. The winding of the wire is started at the projection 25a and completed at the projection 25b.

To the elastic support members 16, drive currents for focusing adjustment, tracking adjustment and tilt adjustment are supplied from the power-supply circuit through the various connecting wires provided on the power-supplying substrate and through the connecting parts 18a to 18f provided on the relay substrate 18. Hence, two of the six elastic support members 16 serve to supply power the first to fourth focusing coils 45 to 48, other two serve to supply power to the first to fourth tracking coils 41 to 44, and the remaining two serve to supply power to the first and second tilt coils 51 and 52.

In the objective-lens driving apparatus 9 thus configured, drive currents may be supplied from the power-supply circuit to the first to fourth focusing coils 45 to 48, first to fourth tracking coils 41 to 44 and first and second tilt coils 51 and 52 through the power-supplying substrate, the relay substrate 18 and the elastic support members 16. When the drive currents are so supplied, the movable unit 12 is moved in the focusing direction F_{CS}, the tracking direction T_{RK} or the tilt direction T_{IL}, in accordance with the relation between the directions of these drive currents and the directions of the magnetic fluxes generated by the first and second magnets 21 and 22 and yoke parts 10b and 10c.

As the movable unit 12 is moved in the focusing direction FCS, the tracking direction T_{RK} or the tilt direction T_{IL}, the elastic support members 16 are elastically deformed.

The lens holder 15 remains at the position neutral with respect to the focusing direction F_{CS} as long as a drive current is supplied to none of the first to fourth focusing coils 45 to 48. The lens holder 15 remains at the position neutral with respect to the tracking direction T_{RK} as long as a drive current is supplied to none of the first to fourth tracking coils 41 to 44. Further, the lens holder 15 remains at the position neutral with respect to the tilt direction T_{IL} as long as a drive current is supplied to neither the first tilt coil 51 nor the second tilt coil 52.

In the optical disc apparatus 1 thus configured, the disc table 4 rotates as the spindle motor is driven. When the disc table 4 rotates, the optical disc 2 placed on the disc table 4 is rotated. At the same time, the optical pickup 7 is moved in the radial direction of the optical disc 2 and records or reproduces data in or from the optical disc 2.

During the data-recording process or the data-reproducing process, a drive current may be supplied to the first to fourth focusing coils 45 to 48. In this case, the movable unit 12 of the objective-lens driving apparatus 9 is moved in the focusing direction F_{CS} (shown in FIG. 5) with respect to the fixed unit 11. The light source (not shown) that is provided on the movable base 8 emits a laser beam. The laser beam is applied through the objective lens 14, forming a laser-beam spot on the optical disc 2. The focusing adjustment is performed so that the laser-beam spot may illuminate a recording track provided on the optical disc 2.

When a drive current is supplied to the first to fourth tracking coils 41 to 44, the movable unit 12 of the objective-lens driving apparatus 9 is moved in the tracking direction T_{RK} (shown in FIG. 5) with respect to the fixed unit 11. Thus, the tracking adjustment is carried out so that the laser-beam spot may illuminate the recording track provided on the optical disc 2.

Moreover, when a drive current is supplied to the first and second tilt coils 51 and 52, the movable unit 12 of the objective-lens driving apparatus 9 is moved in the tilt direction T_{IL} (shown in FIG. 5) with respect to the fixed unit 11. Thus, the tilt adjustment is achieved out so that the laser beam may be applied in a direction perpendicular to the surface of the optical disc 2 even if the disc 2 inclines.

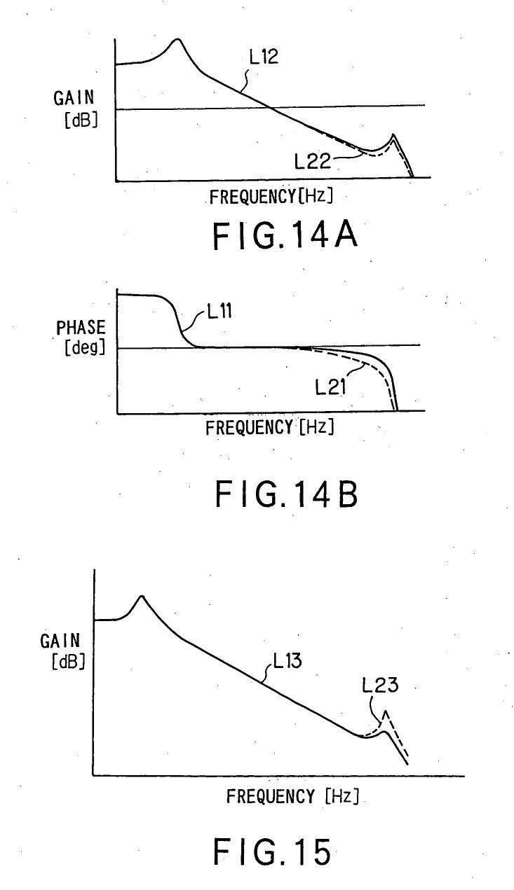

FIG. 14A illustrates how the gain change with the frequency, and FIG. 14B shows how the phase changes with the frequency in the objective-lens driving apparatus 9 so configured as described above. In FIGS. 14A and 14B, solid lines L11 and L12 show how the gain and phase change with the frequency in the objective-lens driving apparatus 9. In these figures, broken lines L21 and L22 depict how the gain and phase change with the frequency in the objective-lens driving apparatus 101, i.e., an example to be compared with the present invention.

As seen from FIGS. 14A and 14B, the objective-lens driving apparatus 9 can reduce the phase delay, making it easy to achieve servo design for high-speed, data-recording/reproducing apparatuses.

FIG. 15 shows how the gain changes with the frequency in the objective-lens driving apparatus 9. In FIG. 15, solid line L13 shows how the gain changes in the objective-lens driving apparatus 9 according to the present invention. In FIG. 15, broken line L23 depicts how the gain changes in the objective-lens driving apparatus 101, i.e., an example to be compared with the present invention.

As seen from FIG. 15, the objective-lens driving apparatus 9 can prevent the primary bending mode from being excited and can therefore exhibit good resonance characteristic in high-frequency bands. By contrast, in the comparative apparatus 101, the peak value increases because the primary bending mode is excited.

As described above, the objective-lens driving apparatus 9 according to this invention uses an open circuit. Hence, a phase delay due to the inductance resulting from the yokes inserted in the focusing coils does not occur as in the conventional apparatus. The phase delay is therefore small, if any. This renders it easy to accomplish, for example, servo design for high-speed, data-recording/reproducing apparatuses.

The objective-lens driving apparatus 9 according to this invention has a plurality of focusing coils 45 to 48 that are spaced apart in the tracking direction T_{RK}. Therefore, focusing drive forces do not excite the primary bending mode in the movable unit. This enables the apparatus 9 to acquire good resonance characteristic in high-frequency bands.

In the objective-lens driving apparatus 9 according to this invention, the first and second tilt coils 51 and 52 can be wound together, not separately, around the lens holder 15. This helps to simplify the structure of the apparatus and lowers the manufacturing cost of the apparatus.

The objective-lens driving apparatus 9 according to this invention has first and second magnets 21 and 22 that have the same shape. They differ only in that they are magnetized in opposite directions. Thus, the apparatus 9 can be readily mass-produced, which serves to lower the manufacturing cost of the apparatus 9.

The first and second magnets 21 and 22 incorporated in the objective-lens driving apparatus 9 described above are integrally formed by means of four-pole magnetization. The present invention is not limited to this. For example, two magnets spaced apart, substantially in the tracking direction T_{RK}, may be two-pole magnetized and may then be combined together.

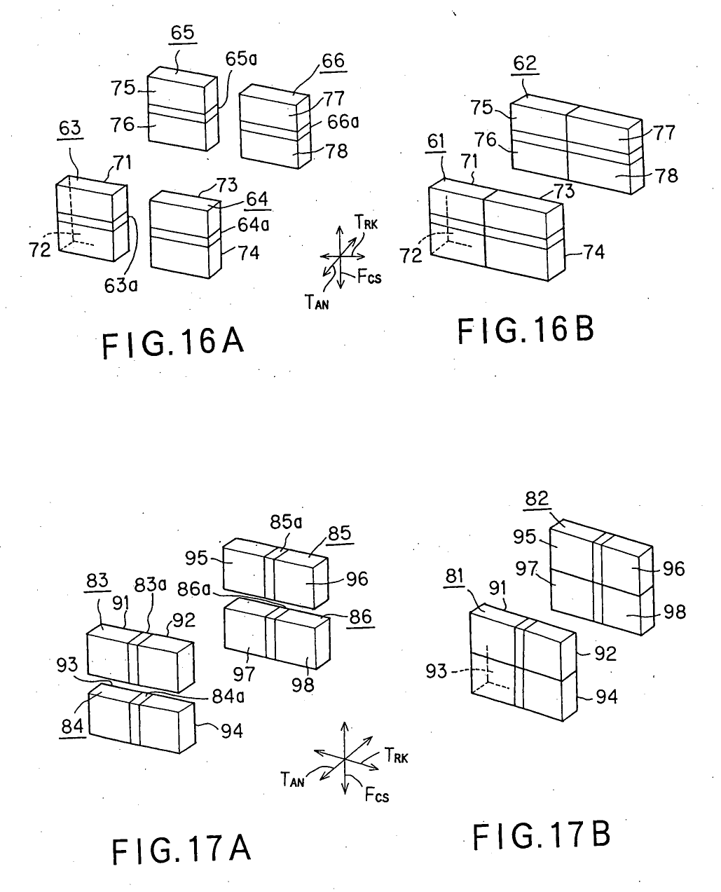

If this is the case, the first magnet 61 is prepared by arranging third and fourth magnets 63 and 64 in the tracking direction T_{RK} and combining them together, as is illustrated in FIG. 16A. Note that the magnets 63 and 64 have been magnetized, forming an upper pole and a lower pole. The second magnet 62 is prepared by arranging fifth and sixth magnets 65 and 66 in the tracking direction T_{RK} and combining them together, said magnets 65 and 66 having magnetized, forming an upper pole and a lower pole. The third to sixth magnets 63 to 66 are all identical.

The third and fourth magnets 63 and 64 are arranged, with their magnetization axes oriented in the tangential direction T_{AN} and their segment regions arranged in the focusing direction F_{CS}. Further, they are so arranged that the segment regions of one magnet are magnetized in the direction opposite to the magnetization direction of the segment regions of the other magnet.

That is, the third magnet 63 includes ninth and tenth segment regions 71 and 72 that are arranged in a plane facing the lens holder 15, spaced apart in the focusing direction F_{CS} and magnetized in the tangential direction T_{AN}. The ninth segment region 71 makes an S pole, and the tenth segment region 72 makes an N pole. As indicated above, the third magnet 63 is two-pole magnetized. The region between the segment regions 71 and 72 is a non-magnetized segment region 63a.

The fourth magnet 64 includes eleventh and twelfth segment regions 73 and 74 that are arranged in a plane facing the lens holder 15, spaced apart in the focusing direction F_{CS} and magnetized in the tangential direction T_{AN}. The eleventh segment region 73 makes an N pole, and the twelfth segment region 74 makes an S pole. As mentioned above, the fourth magnet 64 is two-pole magnetized. The region between the segment regions 73 and 74 is a non-magnetized segment region 64a.

The third and fourth magnets 63 and 64 are so arranged that the ninth and tenth segment regions 71 and 72 align in the focusing direction F_{CS} and the eleventh and twelfth segment regions 73 and 74 align in the focusing direction F_{CS}, too. The ninth segment region 71 of the third magnet 63 is so arranged that it is magnetized in the direction opposite to the magnetization direction of the eleventh segment region 73 of the fourth magnet 64, which is arranged adjacent in the tracking direction T_{RK}. The first magnet 61 is thereby formed as is illustrated in FIG. 16B. In this state, the tenth segment region 72 of the third magnet 63 is magnetized in the direction opposite to the magnetization direction of the twelfth segment region 74 of the fourth magnet 64, which is arranged adjacent in the tracking direction T_{RK}. The third and fourth magnets 63 and 64 may be jointed together with adhesive or the like. Alternatively, they may be jointed by virtue of magnetic force only.

The ninth and tenth segment regions 71 and 72 of the third magnet 63 and the eleventh and twelfth segment regions 73 and 74 of the fourth magnet 64 function as first to fourth segment regions of the first magnet 61. Like the first magnet 21, the third and fourth magnets 63 and 64 generate magnetic fields that provide drive forces for moving the lens holder in the focusing direction F_{CS}, tracking direction T_{RK} and tilt direction T_{IL}, jointly with the currents that flow through the focusing coils, tracking coils and tilt coils.

The fifth and sixth magnets 65 and 66 are arranged in the tangential direction T_{AN} in which they are magnetized. Further, they are so arranged that their segment regions are aligned in the focusing direction F_{CS}. In addition, they are so arranged that one of them have its segment regions magnetized in the direction opposite to the magnetization direction of those of the other magnet that is adjacent to the first-mentioned magnet in the tracking direction T_{RK}.

That is, the fifth magnet 65 has thirteenth and fourteenth segment regions 75 and 76 that face the lens holder 15 in the tangential direction T_{AN}, are spaced apart in the focusing direction F_{CS} and are magnetized in the tangential direction T_{AN}. Here, the thirteenth segment region 75 is an S pole, and the fourteenth segment region 76 is an N pole. As noted above, the fifth magnet 65 is two-pole magnetized. The region between the segment regions 75 and 76 is a non-magnetized segment region 65a.

The sixth magnet 66 has fifteenth and sixteenth segment regions 77 and 78 that face the lens holder 15 in the tangential direction T_{AN}, are spaced apart in the focusing direction F_{CS} and are magnetized in the tangential direction T_{AN}. Here, the fifteenth segment region 77 is an N pole, and the sixteenth segment region 78 is an S pole. As noted above, the sixth magnet 66 is two-pole magnetized. The region between the segment regions 77 and 78 is a non-magnetized segment region 66a.

The fifth and sixth magnets 65 and 66 are so arranged that the thirteenth and fourteenth segment regions 75 and 76 and the fifteenth and sixteenth segment regions 77 and 78 are aligned in the focusing direction F_{CS}. The thirteenth segment region 75 of the fifth magnet 65 is arranged and jointed to the fifteenth segment region 77 of the sixth magnet 66 adjacent in the tracking direction T_{RK}, so that the segment regions 75 and 77 are magnetized in opposite directions. Thus, the fifth and sixth magnets 65 and 66 constitute the second magnet 62. In this state, the fourteenth segment region 76 of the fifth magnet 65 is magnetized in the direction opposite to the magnetization direction of the sixteenth segment region 78 of the sixth magnet 66, which is arranged adjacent in the tracking direction T_{RK}. The fifth and sixth magnets 65 and 66 may be jointed together with adhesive or the like. The may otherwise be jointed by virtue of magnetic force only.

The thirteenth and fourteenth segment regions 75 and 76 of the fifth magnet 65 and the fifteenth and sixteenth segment regions 77 and 78 of the sixth magnet 66 serve as the fifth to eighth segment regions of the second magnet 62. As in the second magnet 22 described above, they generate not only currents to supply to the focusing coils, tracking coils and tilt coils, but also magnetic fields that provide drive forces acting in the focusing direction F_{CS}, tracking direction T_{RK} and tilt direction T_{IL}.

An objective-lens driving apparatus according to this invention, which includes such first and second magnets 61 and 62 as described above, has an open magnetic path, like the objective-lens driving apparatus 9 that has been described. In the apparatus, phase delays do not develop from the inductance resulting from the yokes that are inserted in the focusing coils as in the conventional apparatus. Phase delay, if any, can therefore be reduced. It is therefore easy to accomplish, for example, servo design for high-speed, data-recording/reproducing apparatuses. Moreover, since a plurality of focusing coils are spaced apart in the tracking direction T_{RK}, focusing drive forces do not excite the primary bending mode in the movable unit. The objective-lens driving apparatus can therefore acquire good resonance characteristic in high-frequency bands.

In the objective-lens driving apparatus that has the first and second magnets 61 and 62, the third to sixth magnets 63 to 66 are identical. The apparatus can therefore be readily mass-produced, which helps to lower the manufacturing cost of the objective-lens driving apparatus.

Furthermore, in the objective-lens driving apparatus including the first and second magnets 61 and 62, neither the border region between the third and fourth magnets 63 and 64 nor the border region between the fifth and sixth magnets 65 and 66 is a non-magnetized segment region. This can enhance the tracking sensitivity.

The first and second magnets incorporated in the objective-lens driving apparatus 9 may be each composed of two magnets that are two-pole magnetized and spaced apart in the focusing direction F_{CS}.

As shown in FIG. 17A, the first magnet 81 is composed of, for example, seventh and eighth magnets 83 and 84 each divided into two parts, which are magnetized, forming a left pole and a right pole that are arranged in the focusing direction F_{CS} and jointed to each other. The second magnet 82 is composed of, for example, ninth and tenth magnets 85 and 86 each divided into two parts, which are magnetized, forming a left pole and a right pole that are arranged in the focusing direction F_{CS} and jointed to each other. The seventh to tenth magnets 83 to 86 are all identical.

The seventh and eighth magnets 83 and 84 are arranged, with their magnetization axes oriented in the tangential direction T_{AN} and their segment regions arranged in the tracking direction T_{RK}. Further, they are so arranged that the segment regions of one magnet are magnetized in the direction opposite to the magnetization direction of those of the other magnet.

That is, the seventh magnet 83 includes seventeenth and eighteenth segment regions 91 and 92 that are arranged in a plane facing the lens holder 15 in the tangential direction T_{AN}, spaced apart in the tracking direction T_{RK} and magnetized in the tangential direction T_{AN}. Here, the seventeenth segment region 91 makes an S pole, and the eighteenth segment region 92 makes an N pole. As indicated above, the seventh magnet 83 is two-pole magnetized. The region between the segment regions 91 and 92 is a non-magnetized segment region 83a.

The eighth magnet 84 includes nineteenth and twentieth segment regions 93 and 94 that are arranged in a plane facing the lens holder 15 in the tangential direction T_{AN}, spaced apart in the tracking direction T_{RK} and magnetized in the tangential direction T_{AN}. Here, the nineteenth segment region 93 makes an N pole, and the twentieth segment region 94 makes an S pole. As mentioned above, the eighth magnet 84 is two-pole magnetized. The region between the segment regions 93 and 94 is a non-magnetized segment region 84a.

The seventh and eighth magnets 83 and 84 are so arranged that the seventeenth and eighteenth segment regions 91 and 92 align in the tracking direction T_{RK} and the nineteenth and twentieth segment regions 93 and 94 align in the tracking direction T_{RK}, too. The seventeenth segment region 91 of the seventh magnet 83 is so arranged that it is magnetized in the direction opposite to the magnetization direction of the nineteenth segment region 93 of the eighteenth magnet 84, which is arranged adjacent in the focusing direction F_{CS}. The first magnet 81 is thereby formed as shown in FIG. 17B. In this state, the eighteenth segment region 92 of the seventh magnet 83 is magnetized in the direction opposite to the magnetization direction of the twentieth segment region 94 of the eighth magnet 84, which is arranged adjacent in the focusing direction F_{CS}. The seventh and eighth magnets 83 and 84 may be jointed together with adhesive or the like. Alternatively, they may be jointed by virtue of magnetic force only.

The seventeenth and eighteenth segment regions 91 and 92 of the seventh magnet 83 and the nineteenth and twentieth segment regions 93 and 94 of the eighth magnet 84 serve as the first to fourth segment regions of the first magnet 81. As in the first magnet 21 described above, they generate not only currents to supply to the focusing coils, tracking coils and tilt coils, but also magnetic fields that provide drive forces acting in the focusing direction F_{CS}, tracking direction T_{RK} and tilt direction T_{IL}.

The ninth and tenth magnets 85 and 86 are arranged in the tangential direction T_{AN} in which they are magnetized. Further, they are so arranged that their segment regions are aligned in the tracking direction T_{RK} In addition, they are so arranged that one of them have its segment regions magnetized in the direction opposite to the magnetization direction of the segment regions of the other magnet that is adjacent to the first-mentioned magnet in the focusing direction F_{CS}.

That is, the ninth magnet 85 has twenty-first and twenty-second segment regions 95 and 96 that face the lens holder 15 in the tangential direction T_{AN}, are spaced apart in the tracking direction T_{RK} and are magnetized in the tangential direction T_{AN}. Here, the twenty-first segment region 95 is an S pole, and the twenty-second segment region 96 is an N pole. As noted above, the ninth magnet 85 is two-pole magnetized. The region between the segment regions 95 and 96 is a non-magnetized segment region 85a.

The tenth magnet 86 has twenty-third and twenty-fourth segment regions 97 and 98 that face the lens holder 15 in the tangential direction T_{AN}, are spaced apart in the tracking direction T_{RK} and are magnetized in the tangential direction T_{AN} Here, the twenty-third segment region 97 is an N pole, and the twenty-fourth segment region 98 is an S pole. As noted above, the tenth magnet 86 is two-pole magnetized. The region between the segment regions 97 and 98 is a non-magnetized segment region 86a.

The ninth and tenth magnets 85 and 86 are so arranged that the twenty-first and twenty-second segment regions 95 and 96 align in the tracking direction T_{RK} and the twenty-third and twenty-fourth segment regions 97 and 98 align in the tracking direction T_{RK}, too. The twenty-first segment region 95 of the ninth magnet 85 is so arranged that it is magnetized in the direction opposite to the magnetization direction of the twenty-third segment region 97 of the tenth magnet 86, which is arranged adjacent in the focusing direction F_{CS}. The second magnet 82 is thereby formed. In this state, the twenty-second segment region 96 of the ninth magnet 85 is magnetized in the direction opposite to the magnetization direction of the twenty-fourth segment region 98 of the tenth magnet 86, which is arranged adjacent in the focusing direction F_{CS}. The ninth and tenth magnets 85 and 86 may be jointed together with adhesive or the like. Alternatively, they may be jointed by virtue of magnetic force only.

The twenty-first and twenty-second segment regions 95 and 96 of the ninth magnet 85 and the twenty-third and twenty-fourth segment regions 97 and 98 of the tenth magnet 86 serve as the fifth to eighth segment regions of the second magnet 82. As in the second magnet 22 described above, they generate not only currents to supply to the focusing coils, tracking coils and tilt coils, but also magnetic fields that provide drive forces acting in the focusing direction F_{CS}, tracking direction T_{RK} and tilt direction T_{IL}.

An objective-lens driving apparatus according to this invention, which includes such first and second magnets 81 and 82 as described above, has an open magnetic path, like the objective-lens driving apparatus 9 that has been described. In the apparatus, phase delays do not develop from the inductance resulting from the yokes that are inserted in the focusing coils as in the conventional apparatus. Phase delay, if any, can therefore be reduced. It is therefore easy to accomplish, for example, servo design for high-speed, data-recording/reproducing apparatuses. Moreover, since a plurality of focusing coils are spaced apart in the tracking direction T_{RK}, focusing drive forces do not excite the primary bending mode in the movable unit. The objective-lens driving apparatus can therefore acquire good resonance characteristic in high-frequency bands.

In the objective-lens driving apparatus that has the first and second magnets 81 and 82, the seventh to tenth magnets 83 to 86 are identical. The apparatus can therefore be readily mass-produced, which helps to lower the manufacturing cost of the objective-lens driving apparatus.

Furthermore, in the objective-lens driving apparatus including the first and second magnets 81 and 82, neither the border region between the seventh and eighth magnets 83 and 84 nor the border region between the ninth and tenth magnets 85 and 86 is a non-magnetized segment region. This can enhance the tracking sensitivity.

The first and second magnets incorporated in the objective-lens driving apparatus 9 may be each composed of four magnets spaced apart in both the tracking direction T_{RK} and the focusing direction F_{CS}. Namely, each of the first and second magnets is composed of four magnets having the same shape. The apparatus 9 can therefore be readily mass-produced, which helps to lower the manufacturing cost of the apparatus 9.

The optical pickup 7 according to this invention has the objective-lens driving apparatus 9 described above. Hence, the optical pickup 7 can perform three-axis adjustment. That is, the apparatus 9 can perform focusing adjustment, tracking adjustment and tilt adjustment, making the laser-beam spot accurately trace the recording track. In addition, the phase delay, i.e., one focusing-response characteristic, can be reduced. Servo design for high-speed, data-recording/reproducing apparatuses can therefore be easily accomplished. Moreover, the focusing drive forces do not excite the primary bending mode in the movable unit. Therefore, the optical pickup 7 can acquire good resonance characteristic in high-frequency bands and can be manufactured at low cost.

The data-recording/reproducing apparatus 1 according to this invention has the objective-lens driving apparatus 9 described above. The apparatus 1 can therefore record and reproduce data at high efficiency, because the apparatus 9 can perform three-axis adjustment. That is, the apparatus 9 can perform focusing adjustment, tracking adjustment and tilt adjustment, making the laser-beam spot accurately trace the recording track. In addition, the phase delay, i.e., one focusing-response characteristic, can be reduced. Servo design for high-speed, data-recording/reproducing apparatuses can therefore be easily accomplished. Moreover, the focusing drive forces do not excite the primary bending mode in the movable unit. Therefore, the data-recording/reproducing apparatus 1 can acquire good resonance characteristic in high-frequency bands and can be manufactured at low cost.

It should be understood by those skilled in the art that various modifications, combinations, sub-combinations and alterations may occur depending on design requirements and other factors insofar as they are within the scope of the appended claims or the equivalents thereof.

What is claimed is:

1. An objective-lens driving apparatus comprising:
a movable unit that has a lens holder holding an objective lens;
a fixed unit that is spaced apart from the movable unit in a tangential direction intersecting at right angle to a focusing direction and tracking direction of the objective lens;
elastic support members that connect the movable unit and the fixed unit to each other, support the movable unit, enabling the movable unit to move with respect to the fixed unit in the focusing direction and tracking direction and to incline in a tilt direction to a plane that is parallel to the tangential direction;
a first magnet that has first to fourth segment regions facing the lens holder in the tangential direction, spaced from one another in the focusing direction and tracking direction and magnetized in the tangential direction; and
a second magnet that is arranged, facing the first magnet in the tangential direction, and is magnetized in a direction opposite to a magnetization direction of the first magnet,
said lens holder having:
tracking coils that are provided at four positions, respectively, for generating drive forces acting in the tracking direction, respectively on the first and second segment regions of the first magnet, which are adjacent in the tracking direction, on the third and fourth segment regions of the first magnet, which are adjacent in the tracking direction, on those segment regions of the second magnet, which face the first and second segment regions, and on those segment regions of the second magnet, which face the third and fourth segment regions;
focusing coils that are provided at four positions, respectively, for generating drive forces acting in the focusing direction, respectively on the first and third segment regions of the first magnet, which are adjacent in the focusing direction, on the second and fourth segment regions of the first magnet, which are adjacent in the focusing direction, on those segment regions of the second magnet, which face the first and third segment regions, and on those segment regions of the second magnet, which face the second and fourth segment regions;
a first tilt coil that is wound around an axis extending in the focusing direction and generates drive forces acting in the tilt direction, respectively on the first and second segment regions of the first magnet, which are adjacent in the tracking direction, and on those segment regions of the second magnet, which face the first and second segment regions; and
a second tilt coil that is wound around in a direction opposite to the winding direction of the first tilt coil, and generates drive forces acting in the tilt direction, respectively on the third and fourth segment regions of the first magnet, which are adjacent in the tracking direction, and on those segment regions of the second magnet, which face the third and fourth segment regions.

2. An optical pickup comprising a movable base that is moved in a radial direction of an optical disc placed on a disc table, and an objective-lens driving apparatus that is arranged on the movable table, said objective-lens driving apparatus comprising:
a movable unit that has a lens holder holding an objective lens;
a fixed unit that is spaced apart from the movable unit in a tangential direction intersecting at right angle to a focusing direction and tracking direction of the objective lens;
elastic support members that connect the movable unit and the fixed unit to each other, support the movable unit, enabling the movable unit to move with respect to the fixed unit in the focusing direction and tracking direction and to incline in a tilt direction to a plane that is parallel to the tangential direction;
a first magnet that has first to fourth segment regions facing the lens holder in the tangential direction, spaced from one another in the focusing direction and tracking direction and magnetized in the tangential direction; and
a second magnet that is arranged, facing the first magnet in the tangential direction, and is magnetized in a direction opposite to a magnetization direction of the first magnet,
said lens holder having:
tracking coils that are provided at four positions, respectively, for generating drive forces acting in the tracking direction, respectively on the first and second segment regions of the first magnet, which are adjacent in the tracking direction, on the third and fourth segment regions of the first magnet, which are adjacent in the tracking direction, on those segment regions of the second magnet, which face the first and second segment regions, and on those segment regions of the second magnet, which face the third and fourth segment regions;
focusing coils that are provided at four positions, respectively, for generating drive forces acting in the focusing direction, respectively on the first and third segment regions of the first magnet, which are adjacent in the focusing direction, on the second and fourth segment regions of the first magnet, which are adjacent in the focusing direction, on those segment regions of the second magnet, which face the first and third segment regions, and on those segment regions of the second magnet, which face the second and fourth segment regions;
a first tilt coil that is wound around an axis extending in the focusing direction and generates drive forces acting in the tilt direction, respectively on the first and second segment regions of the first magnet, which are adjacent in the tracking direction, and on those segment regions of the second magnet, which face the first and second segment regions; and
a second tilt coil that is wound around in a direction opposite to the winding direction of the first tilt coil, and generates drive forces acting in the tilt direction, respectively on the third and fourth segment regions of the first magnet, which are adjacent in the tracking direction, and on those segment regions of the second magnet, which face the third and fourth segment regions.

3. The optical pickup according to claim 2, wherein the first and second magnets are formed in the same shape and magnetized in opposite directions.

4. The optical pickup according to claim 2, wherein a projection is provided on a surface of the lens holder and between the first tilt coil and the second tilt coil, said surface being perpendicular to the tracking direction, and the first and second tilt coils are formed, by winding a wire in a predetermined direction, forming the first tilt coil, by passing the wire around the projection, and by winding the wire in a direction opposite to the predetermined direction, forming the second tilt coil.

5. The optical pickup according to claim 4, wherein the projection is one of an attachment portion of said plurality of elastic support members.

6. The optical pickup according to claim 2, wherein the first magnet is formed by arranging third and fourth magnets in the tracking direction, each divided into two parts, which are magnetized, forming an upper pole and a lower pole; the second magnet is formed by arranging fifth an sixth magnets in the tracking direction, each divided into two parts, which are magnetized, forming an upper pole and a lower pole; the third and fourth magnets are arranged with magnetized axes oriented in the tangential direction, each of the third and fourth magnets has segment regions arranged in the focusing direction, and the segment regions of one of the third and fourth magnets are magnetized in a direction opposite to the magnetizing direction of the segment regions of the other of the third and fourth magnets, which are adjacent in the tracking direction; the fifth and sixth magnets are arranged with magnetized axes oriented in the tangential direction, each of the fifth and sixth magnets has segment regions arranged in the focusing region, and the segment regions of one of the fifth and sixth magnets are magnetized in a direction opposite to the magnetizing direction of the segment regions of the other of the fifth and sixth magnets, which are adjacent in the tracking direction.

7. The optical pickup according to claim 6, wherein the third to sixth magnets are all identical.

8. The optical pickup according to claim 2, wherein the first magnet is formed by arranging seventh and eighth magnets in the focusing direction, each divided into two parts, which are magnetized, forming a left pole and a right pole; the second magnet is formed by arranging ninth and tenth magnets in the focusing direction, each divided into two parts, which are magnetized, forming a left pole and a right pole; the seventh and eighth magnets are arranged with magnetized axes oriented in the tangential direction, each of the seventh and eighth segments has segment regions arranged in the tracking direction, and the segment regions of one of the seventh and eighth magnets are magnetized in a direction opposite to the magnetizing direction of the segment regions of the other of the seventh and eighth magnets, which are adjacent in the focusing direction; the ninth and tenth magnets are arranged with magnetized axes oriented in the tangential direction, each of the ninth and tenth magnets has segment regions arranged in the tracking direction, and the segment regions of one of the ninth and tenth magnets are magnetized in a direction opposite to the magnetizing direction of the segment regions of the other of the ninth and tenth magnets, which are adjacent in the focusing direction.

9. The optical pickup according to claim 8, wherein the seventh to tenth magnets are all identical.

10. An optical disc apparatus comprising a disc table on which an optical disc is to be placed, and an optical pickup which applies a laser beam through an objective lens to the optical disc placed on the disc table, said optical pickup having a movable base that is moved in a radial direction of an optical disc placed on a disc table, and an objective-lens driving apparatus that is arranged on the movable table, said objective-lens driving apparatus comprising:
a movable unit that has a lens holder holding an objective lens;
a fixed unit that is spaced apart from the movable unit in a tangential direction intersecting at right angle to a focusing direction and tracking direction of the objective lens;
elastic support members that connect the movable unit and the fixed unit to each other, support the movable unit, enabling the movable unit to move with respect to the fixed unit in the focusing direction and tracking direction and to incline in a tilt direction to a plane that is parallel to the tangential direction;
a first magnet that has first to fourth segment regions facing the lens holder in the tangential direction, spaced from one another in the focusing direction and tracking direction and magnetized in the tangential direction; and
a second magnet that is arranged, facing the first magnet in the tangential direction, and is magnetized in a direction opposite to a magnetization direction of the first magnet,
said lens holder having:
tracking coils that are provided at four positions, respectively, for generating drive forces acting in the tracking direction, respectively on the first and second segment regions of the first magnet, which are adjacent in the tracking direction, on the third and fourth segment regions of the first magnet, which are adjacent in the tracking direction, on those segment regions of the second magnet, which face the first and second segment regions, and on those segment regions of the second magnet, which face the third and fourth segment regions;
focusing coils that are provided at four positions, respectively, for generating drive forces acting in the focusing direction, respectively on the first and third segment regions of the first magnet, which are adjacent in the focusing direction, on the second and fourth segment regions of the first magnet, which are adjacent in the focusing direction, on those segment regions of the second magnet, which face the first and third segment regions, and on those segment regions of the second magnet, which face the second and fourth segment regions;
a first tilt coil that is wound around an axis extending in the focusing direction and generates drive forces acting in the tilt direction, respectively on the first and second segment regions of the first magnet, which are adjacent in the tracking direction, and on those segment regions of the second magnet, which face the first and second segment regions; and
a second tilt coil that is wound around in a direction opposite to the winding direction of the first tilt coil, and generates drive forces acting in the tilt direction, respectively on the third and fourth segment regions of the first magnet, which are adjacent in the tracking direction, and on those segment regions of the second magnet, which face the third and fourth segment regions.

11. The optical disc apparatus according to claim 10, wherein the first and second magnets are formed in the same shape and magnetized in opposite directions.

12. The optical disc apparatus according to claim 10, wherein a projection is provided on a surface of the lens holder and between the first tilt coil and the second tilt coil, said surface being perpendicular to the tracking direction, and the first and second tilt coils are formed, by winding a wire in a predetermined direction, forming the first tilt coil, by passing the wire around the projection, and by winding the wire in a direction opposite to the predetermined direction, forming the second tilt coil.

13. The optical disc apparatus according to claim 12, wherein the projection is one of an attachment portion of said plurality of elastic support members.

14. The optical disc apparatus according to claim 10, wherein the first magnet is formed by arranging third and fourth magnets in the tracking direction, each divided into two parts, which are magnetized, forming an upper pole and a lower pole; the second magnet is formed by arranging fifth an sixth magnets in the tracking direction, each divided into two parts, which are magnetized, forming an upper pole and a lower pole; the third and fourth magnets are arranged with magnetized axes oriented in the tangential direction, each of the third and fourth segments has segment regions arranged in the focusing direction, and the segment regions of one of the third and fourth magnets are magnetized in a direction opposite to the magnetizing direction of the segment regions of the other of the third and fourth magnets, which are adjacent in the tracking direction; the fifth and sixth magnets are arranged with magnetized axes oriented in the tangential direction, each of the fifth and sixth magnets has segment regions arranged in the focusing region, and the segment regions of one of the fifth and sixth magnets are magnetized in a direction opposite to the magnetizing direction of the segment regions of the other of the fifth and sixth magnets, which are adjacent in the tracking direction.

15. The optical disc apparatus according to claim 14, wherein the third to sixth magnets are all identical.

16. The optical disc apparatus according to claim 10, wherein the first magnet is formed by arranging seventh and eighth magnets in the focusing direction, each divided into two parts, which are magnetized, forming a left pole and a right pole; the second magnet is formed by arranging ninth and tenth magnets in the focusing direction, each divided into two parts, which are magnetized, forming a left pole and a right pole; the seventh and eighth magnets are arranged with magnetized axes oriented in the tangential direction, each of the seventh and eighth segments has segment regions arranged in the tracking direction, and the segment regions of one of the seventh and eighth magnets are magnetized in a direction opposite to the magnetizing direction of the segment regions of the other of the seventh and eighth magnets, which are adjacent in the focusing direction; the ninth and tenth magnets are arranged with magnetized axes oriented in the tangential direction, each of the ninth and tenth magnets has segment regions arranged in the tracking direction, and the segment regions of one of the ninth and tenth magnets are magnetized in a direction opposite to the magnetizing direction of the segment regions of the other of the ninth and tenth magnets, which are adjacent in the focusing direction.

17. The optical disc apparatus according to claim 16, wherein the seventh to tenth magnets are all identical.
